(19) United States
(12) Patent Application Publication
(10) Pub. No.: US 2007/0231510 A1
(43) Pub. Date: Oct. 4, 2007

(54) Ink-Jet Receiver Having Improved Crack Resistance

(76) Inventor: Julie Baker, Leavesden (GB)

Correspondence Address: EASTMAN KODAK COMPANY;PATENT LEGAL STAFF, 343 STATE STREET, ROCHESTER, NY, 14650-2201, US

(21) Appl. No.: 11/570,591

(22) PCT Filed: Jun. 30, 2005
(86) PCT No.: PCT/GB05/02559

§ 371 Date: Dec. 14, 2006

(30) Foreign Application Priority Data
Jul. 7, 2004 (GB) 0415211.2

(51) Int. Cl. B41M 5/00

(52) U.S. Cl. 428/32.28; 29/890.1; 347/1; 428/32.1

(57) ABSTRACT

An ink jet receiver having a support; an under layer comprising an inorganic particulate material and a binder, said binder being present in an amount of up to 25% by weight of the combined weight of inorganic particulate material and binder in the under layer; and an upper layer comprising a binder, a first inorganic particulate material having a mean particulate diameter of 500 nm or less and a second inorganic particulate material having a mean particulate diameter of 200 nm or less, wherein said second inorganic particulate material has a mean particulate diameter less than that of said first inorganic particulate material and is present in an amount of up to 25% by weight of the total inorganic particulate material laydown in the upper layer, has a reduced propensity to cracking whilst minimising puddling and associated coalescence and ensuring excellent image properties.

### FIELD OF THE INVENTION

The present invention relates to the field of ink-jet printing and to ink-jet applications requiring a porous ink-jet receiver. More particularly, the present invention relates to a porous ink-jet receiver, especially for use with pigmented inks, having improved resistance to cracking during and after manufacture and to a method of making such a receiver.

### BACKGROUND OF THE INVENTION

Ink-jet receivers are generally classified in one of two categories according to whether the principal component material forms a layer that is “porous” or “non-porous” in nature. Many commercial photo-quality porous receivers are made using a relatively low level of a polymeric binder to lightly bind inorganic particles together to create a network of interstitial pores which absorb ink by capillary action. These receivers can appear to dry immediately after printing and consequently are often the preferred technology as the speed and quantity of ink applied increases. A common problem with such porous receivers, however, is that when the materials dry during the manufacturing process, the surface of the coating often cracks.

There is a great deal of effort focussed on providing porous ink-jet receivers having improved properties.

US-A-2002/0150736 (Quintens et al) describes a method for preparing an inkjet recording element improved with regard to the occurrence of cracking by coating a support with a layer having 60-98% by weight inorganic particles (e.g. silica) and, simultaneously, wet on wet, a top layer containing a water-soluble polymer (e.g. poly(diallyldimethylammonium chloride)). Optionally, the element comprises an undercoat layer, which is coated as an aqueous medium comprising an adhesive polymer.

US-A-2004/0043163 (Van Aert et al) describes an ink-jet receiver comprising a support and at least one porous ink receiving layer containing a pigment (which may include calcium carbonate or silica) and a polymeric binder of a particular structure (e.g. a polymer or copolymer derived from a diacetone (meth)acrylamide monomer) that can either self-crosslink, enhance the crosslinking of a separate crosslinker, or its functional group can give an interaction with the inorganic pigment. The use of this particular class of binders in a porous ink receiving layer is shown to provide a receiver with high gloss without imparting negative physical properties such as increased cracking.

U.S. Pat. No. 6,456,086 (Kitamura et al) describes the preparation of an ink-jet recording medium having high gloss, a high ink-absorptive capacity and good sharpness. It discloses an ink-jet receiver having at least two layers coated on a support, which layers comprise a binder and secondary particles of a pigment (e.g. calcium carbonate or silica) having an average secondary particle size of 10 to 400 nm, which secondary particles are formed from primary particles having a primary particle size of 3 to 40 nm, the average primary particle size being larger in the under recording layer than in the upper recording layer. In each of the layers, the ratio of inorganic particles to binder is controlled. When the proportion of binder is too high, the ink-absorbing rate is low, but when the proportion of binder is too low, the coating appears cracked.

U.S. Pat. No. 6,284,819 (Darsillo et al) describes an ink-jet recording medium, which is described as having a high rate of absorption, and of being non-brittle, crack resistant and glossy. The ink-jet recording medium described comprises a substrate having one or more coatings, which may be the same or different, at least one of which coatings comprising a binder and a first and a second group of particles, where the first group of particles have a mean aggregate diameter of between 100 nm and 500 nm (e.g. fumed silica) and the mean diameter of the particles in the second group (e.g. colloidal silica) is less than 50% of the mean aggregate diameter of the first group, and wherein the ratio of particles in the first group to particles in the second group is from about 0.1:1 to about 10:1 by weight. It is stated that if a recording medium comprising a substrate with a highly absorptive glossy coating is desired, the relative quantity of particles from the first group can be increased, and the relative quantity of particles from the second group decreased, whilst if a recording medium comprising a substrate with a highly durable, crack-resistant, non-brittle, adherent glossy coating is desired, the relative quantity of particles from the first group can be decreased and the relative quantity of particles from the second group increased. There is no disclosure of the composition of any further layer that may be included.

The occurrence of cracking is particularly problematic in porous ink-jet receivers comprising high proportions of inorganic particulate materials when the ink-receiving layer is coated onto non resin-coated support. Accordingly it would be desirable to provide an ink-jet receiver having reduced tendency to cracking and improved cracking-resistance even when formed on a non resin-coated support.

### PROBLEM TO BE SOLVED BY THE INVENTION

It is, therefore, an object of the invention to provide a porous ink-jet receiver, which has reduced propensity to cracking, whilst minimising puddling of ink on the surface of the receiver.

It is a further object of the invention to provide a porous ink-jet receiver, which has improved crack resistance, even when the ink receiving layer(s) are coated onto a non resin-coated support.

It has been found by the present inventor that the propensity to cracking of a receiver having an upper layer comprising a binder and a mixture of colloidal silica and fumed silica and an under layer comprising a binder and calcium carbonate can be controlled by varying the relative amounts of colloidal silica in the upper layer and binder in the under layer and that by carefully selecting the amounts of each of those components relative to each other, cracking can be controlled whilst retaining the rate of ink-uptake thereby minimizing puddling.

### SUMMARY OF THE INVENTION

Accordingly, in a first aspect of the invention, there is provided an ink-jet receiver having a support; an under layer comprising an inorganic particulate material and a binder, said binder being present in an amount of up to 25% by weight of the combined weight of inorganic particulate material and binder in the under layer; and an upper layer comprising a binder, a first inorganic particulate material having a mean diameter of 500 nm or less and a second inorganic particulate material having a mean diameter of 200 nm or less, wherein said second inorganic particulate material has a mean diameter less than that of said first inorganic particulate material and is present in an amount of up to 25% by weight of the total inorganic particulate material laydown in the upper layer.

In a second aspect of the invention, there is provided a method of manufacturing an ink-jet receiver as described above, said method comprising coating a first coating formulation onto a support to form an under layer on said support, said first coating formulation comprising an aqueous dispersion of an inorganic particulate material and a binder, said binder being present in an amount of up to 25% by weight of the combined weight of inorganic particulate material and binder; coating onto said first coating formulation a second coating formulation to form an upper layer on said under layer, said second coating formulation comprising an aqueous dispersion of a binder, a first inorganic particulate material having a mean diameter of 500 nm or less and a second inorganic particulate material having a mean diameter of 200 nm or less, wherein said second inorganic particulate material has a mean diameter less than that of said first inorganic particulate material and is present in an amount of up to 25% by weight of the total inorganic particulate material laydown in the upper layer; and drying the coated support.

In a third aspect of the invention, there is provided the use of a binder material to prevent cracking in an ink-jet receiver comprising a support, an under layer comprising a binder and an inorganic particulate material and an upper layer comprising a binder and a mixture of a first inorganic particulate material having a mean diameter of 500 nm or less and a second inorganic particulate material having a mean diameter of 200 nm or less, which said second inorganic particulate material has a mean diameter less than that of said first inorganic particulate material, by incorporating said binder material in the under layer in varying amounts relative to the second inorganic particulate material thereby preventing cracking whilst controlling rate of ink uptake

In a fourth aspect of the invention, there is provided a method of printing, said method comprising the steps of providing an ink-jet printer capable of responding to digital data signals, providing said printer with ink, providing the printer with an ink-jet receiver as defined above, and causing a set of digital signals corresponding to a desired printed image to be sent to said printer.

In a fifth aspect of the invention, there is provided a printed receiver comprising an image printed onto a receiver as described above, by the above described method.

### ADVANTAGEOUS EFFECT OF THE INVENTION

The ink-jet receiver according to the invention is capable of achieving a high rate of ink-absorption whilst having a reduced propensity to cracking during and after manufacture, even when the support is a non resin-coated support such as non resin-coated paper. The ink-jet receiver may also exhibit high gloss and excellent printing properties, including excellent image density and is particularly advantageous when used with pigmented inks.

### DETAILED DESCRIPTION OF THE INVENTION

The ink-jet receiver of the present invention, which has excellent printing properties and exhibits a reduced propensity to cracking without substantial puddling of ink on the surface thereof, comprises a support, an under layer comprising an inorganic particulate material and a binder, said binder being present in an amount of up to 25% by weight of the combined weight of inorganic particulate material and binder in the under layer and an upper layer comprising a binder, a first inorganic particulate material having a mean particulate diameter of 500 nm or less and a second inorganic particulate material having a mean particulate diameter of 200 nm or less, wherein said second inorganic particulate material has a mean particulate diameter less than that of said first inorganic particulate material and is present in an amount of up to 25% by weight of the total inorganic particulate material laydown in the upper layer.

The amount of binder in the under layer and the amount of the second inorganic particulate material in the upper layer may be varied to control the propensity to cracking of the receiver and the extent and occurrence of puddling (and associated coalescence). The precise amounts of binder in the under layer and of the second inorganic particulate material in the upper layer may depend upon the particular balance of cracking prevention and puddling occurrence desired and may also depend on the exact nature and physical features of the particulate materials used in each of the upper and lower layers, the nature of the binders used, the relative thickness of the respective layers, the properties of particulate materials used in each layer and on the presence or not of any further layers.

Depending upon these variables, the amount of binder in the under layer and the amount of the second inorganic particulate material in the upper layer may be used to control both the amount of cracking and the amount of puddling in the resultant ink-jet receiver.

Preferably, the ink-jet receiver according to the present invention comprises a subbing layer between the support and the under layer. The subbing layer is preferably coated onto the support prior to coating the under layer, e.g. the subbing layer may be coated in a separate pass of a coating station to that of the under layer.

The subbing layer, which improves the adhesion of the under layer to the support, typically comprises a polymer material, such as sulfonated polyesters, gelatin, poly(vinyl pyrrolidone), cellulose ethers and their derivatives such as methyl cellulose, capable of improving the adhesion of the under layer to the support. Preferably the subbing layer comprises a boric acid, borate or derivative and/or salt thereof. Suitable boric acid, borates and derivatives and/or salts thereof include sodium borates, derivatives of boric acid, boric anhydride and the like. A particularly preferred borate is sodium tetraborate decahydrate, which is available from Borax Limited under the trade name Borax® Decahydrate.

The subbing layer preferably comprises a polymer that does not substantially react with the boric acid, borate, derivative or salt thereof, and more preferably does not cross-link with the boric acid, borate, derivative or salt thereof at all. Examples of suitable such polymers include sulfonated polyesters, gelatin, poly(vinyl pyrrolidone), cellulose ethers and their derivatives such as methyl cellulose, most preferably a sulfopolyester, which is available from Eastman Chemical Company under the trade name Eastek® 1400.

Optional additional components for inclusion in the subbing layer include surfactants, for facilitating coating of the subbing layer onto the support.

The relative amounts of boric acid, borate, derivative or salt thereof and polymer in the subbing layer may be adjusted as desired, with regard, for example, to beneficial properties described in our co-pending UK Patent Application of even date (our reference: 88445GB), the content of which is incorporated herein by reference, and are preferably present in a weight for weight ratio of polymer to boric acid, borate, derivative or salt thereof of from 80:20 to 40:60, more preferably from 75:25 to 60:40 and still more preferably about 70:30. The dry laydown of the boric acid, borate, derivative or salt thereof is preferably varied depending upon the amount of binder present in the preferably adjacent under layer such that, for example, the weight for weight ratio of binder in the under layer to boric acid, borate, derivative or salt thereof in the subbing layer is from 20:1 to 1:1, more preferably 5:1 to 3:1 and most preferably about 4:1.

In the upper layer of the ink-jet receiver according to the present invention, the second inorganic particulate material preferably has a mean particulate diameter of from 25% to 75% of that of the first inorganic particulate material, more preferably of from 40% to 70%.

The second inorganic particulate material is preferably present in an amount of from 3% to 20% by weight of the total inorganic particulate material laydown in the upper layer, more preferably 5% to 15%.

The second inorganic particulate material, which has a mean particulate diameter of 200 nm or less, preferably has a mean particulate diameter of 60 to 100 nm, more preferably 70 to 90 nm and most preferably about 80 nm.

The second inorganic particulate material may be any suitable inorganic particulate meeting the above particle size requirements and capable of forming a porous receiving layer with the first inorganic particulate material and a suitable binder in the aforementioned relative amounts and which ideally is capable, by utilizing incrementally increasing amounts, relative to the first inorganic particulate material, of incrementally reducing the amount of cracking in the ink-jet receiver formed. Suitable such inorganic particulate materials may include, for example silica (e.g. colloidal silica), alumina (e.g. alumina sols, colloidal alumina, cationic aluminium oxide or hydrates thereof, pseudoboehmite, etc.), surface-treated cationic colloidal silica, magnesium silicate, aluminium silicate, magnesium carbonate, kaolin, talc, calcium sulfate, barium sulfate, titanium dioxide, zinc oxide, zinc sulfide, zinc carbonate, satin white, diatomaceous earth, calcium silicate, aluminium hydroxide, lithopone, zeolites (such as molecular sieves 3A, 4A, 5A and 13X), hydrated hallocyte and magnesium hydroxide. Preferably, the second inorganic particulate material is a colloidal silica. Examples of suitable colloidal silicas include, for example, Nalco® 1115 (4 nm), Ludox® SM-30 (7 nm), Ludox® LS-30 (12 nm), Ludox® TM-40 (22 nm), Ludox® AM (˜30 nm), Ludox® TM-30 (˜50 nm) and Ludox® PW-50 (˜80 nm), or a mixture thereof.

The first inorganic particulate material, which may be an agglomerated particulate material or a primary particulate material, and which has a mean particulate diameter of 500 nm or less, preferably has a mean particulate diameter of from 120 to 180 nm, more preferably 140 to 160 nm and most preferably about 150 nm. Where the first inorganic particulate material is an agglomerated particulate material, the agglomerated particles may be composed of particles having a primary mean diameter of up to 50 nm, preferably at least 1 nm, more preferably up to 40 nm, still more preferably up to 30 nm, still more preferably up to 25 nm and most preferably from 15 to 25 nm. The first inorganic particulate material may be any suitable inorganic particulate meeting the above particle size requirements and capable of forming a porous receiving layer with the second inorganic particulate material and a suitable binder in the aforementioned relative amounts. Suitable such inorganic particulate materials may include, for example, one or more metal oxides such a silica, alumina, titania, zirconia, ceria and magnesia, with fumed metal oxides and finely milled metal oxide gels being preferred, and fumed silica being most preferred.

Preferably, the first inorganic particulate material comprises fumed silica and the second inorganic particulate material comprises colloidal silica.

The binder used in the upper layer of the ink-jet receiver may be any binder capable of effectively binding the first and second inorganic particular materials to form a porous ink-receiving layer capable of retaining a pigment or dye, preferably a pigment, to form a printed image having good image properties. Suitable such binders include, for example, one or more of naturally occurring hydrophilic colloids and gums such as gelatin, albumin, guar, xantham, acacia and chitosan and their derivatives, functionalised proteins, functionalised gums and starches, cellulose ethers and their derivatives, such as hydroxyethyl cellulose, hydroxypropyl cellulose and carboxymethyl cellulose, polyvinyl oxazoline and polyvinyl methyloxazoline, polyoxides, polyethers, poly(ethylene imine), poly(acrylic acid), poly(methacrylic acid), n-vinyl amides including polyacrylamide and polyvinyl pyrrolidone, polyethylene oxide and polyvinyl alcohol, its derivatives and copolymers and most preferably polyvinyl alcohol.

Preferably, the binder is present in the upper layer in an amount as a ratio of inorganic particulate materials to binder of from 70:30 to 99:1, preferably 75:25 to 96:4 and still more preferably 85:15 to 95:5.

Other components which may be present in the upper layer of an ink-jet receiver according to the present invention include, for example, a surfactant and a mordant. Suitable surfactants for use in the top layer, for example to improve coatability of the coating composition, depending upon the coating method used, include fluorosurfactants such as Lodyne® S100 or Zonyl® FSN, or a non-fluoro surfactants such as Olin® 10G. Preferably a fluorosurfactants such as Zonyl® FSN is utilised.

Suitable mordants, which may be useful to bind the dye or pigment in the ink in the upper part of the ink-receiving layer in order to improve still further the image density, include, for example, a cationic polymer, e.g. a polymeric quaternary ammonium compound, or a basic polymer, such as poly(dimethylaminoethyl)methacrylate, polyalkylenepolyamines, and products of the condensation thereof with dicyanodiamide, amine-epichlorohydrin polycondensates, divalent Group 11 metal ions, lecithin and phospholipid compounds or any suitable mordant that is capable of assisting with fixing a dye material transferred to it. Examples of such mordants include vinylbenzyl trimethyl ammonium chloride/ethylene glycol dimethacrylate, poly(diallyl dimethyl ammonium chloride), poly(2-N,N,N-trimethylammonium)ethyl methacrylate methosulfate, poly(3-N,N,N-trimethylammonium)propyl chloride. A preferred mordant would be a quaternary ammonium compound.

Optionally, the upper layer may comprise an amorphous hydrated aluminosilicate, such as an allophane, for the reduction of smearing of an image when a printed receiver is stored at high temperatures and humidities.

The inorganic particulate material utilised in the under layer of the ink-jet receiver according to the present invention may be any suitable particulate material capable of, for example, behaving as a sump for a fluid (e.g. water or aqueous alcohol solution) of an ink to be applied to the receiver, when said particulate material is lightly bound by a suitable binder. Preferably, the particulate material in the under layer has a larger mean particulate diameter than the second inorganic particulate material of the upper layer and more preferably a larger mean particulate diameter than the first inorganic particulate material. Suitable such inorganic particulate materials for use in the under layer include, for example, calcium carbonate, magnesium carbonate, kaolin, talc and zeolite(s).

Preferably, the inorganic particulate material in the under layer is calcium carbonate.

A suitable binder for use in binding the inorganic particulate material in the under layer may be any binder capable of effectively binding the inorganic particular material to form an under layer effective as a sump for carrier fluid used in ink to be applied to the receiver. Suitable such binders include, for example, one or more of naturally occurring hydrophilic colloids and gums such as gelatin, albumin, guar, xantham, acacia and chitosan and their derivatives, functionalised proteins, functionalised gums and starches, cellulose ethers and their derivatives, such as hydroxyethyl cellulose, hydroxypropyl cellulose and carboxymethyl cellulose, polyvinyl oxazoline and polyvinyl methyloxazoline, polyoxides, polyethers, poly(ethylene imine), poly(acrylic acid), poly(methacrylic acid), n-vinyl amides including polyacrylamide and polyvinyl pyrrolidone, polyethylene oxide and polyvinyl alcohol, its derivatives and copolymers, more preferably a binder capable of being cross-linked by boric acid, borates and derivative and/or salts thereof and most preferably polyvinyl alcohol.

Preferably, the binder in the under layer is present in an amount of 1% to 20% by weight of the combined weight of inorganic particulate material and binder in the under layer, more preferably from 2% to 10% by weight of the combined weight of inorganic particulate material and binder in the under layer.

Optionally other components may be present in the under layer of the ink-jet receiver, such as a surfactant to improve coatability of the coating composition, depending upon the coating method used. Suitable such surfactants include fluorosurfactants such as Lodyne® S100 or Zonyl® FSN, or a non-fluoro surfactants such as Olin® 10G.

The support may be any support suitable for use in an ink-jet receiver, such as paper, resin-coated paper, film base, acetate, polyethylene terephthalate (PET), a printing plate support, aluminium foil, latex-treated polyester or any other suitable support. The invention is found to be particularly advantageous when the support is a non resin-coated support. Preferably the support is non resin-coated paper.

In a particularly preferred embodiment of the present invention, the ink-jet receiver comprises a subbing layer which comprises a boric acid, borate, derivative and/or salt thereof, coated onto a support, which is preferably a non resin-coated paper support; an under layer coated onto the subbing layer, which under layer comprises calcium carbonate and a binder; and an upper layer coated onto the under layer, which upper layer comprises a binder and a mixture of fumed silica and colloidal silica. Preferably, the binder utilised in both the upper layer and the under layer is polyvinyl alcohol.

Any suitable coating method may be used to coat the layers of the ink-jet receiver onto the support, including, amongst others, curtain coating, bead coating, extrusion coating, air knife coating, rod coating or blade coating. Preferably, the layers are coated by extrusion coating.

Any subbing layer is preferably coated onto the support prior to and separately from the under and upper layers of the ink-jet receiver. The upper and under layers may then be coated simultaneously, optionally as adjacent layers, or separately. Preferably the upper layer and the under layer are each coated as a single layer, but optionally either or both of the upper and under layers may be coated as two or more layers which layers may have the same or different compositions.

The support is preferably coated to provide a dry weight of up to about 25 g/m² of material in the upper layer, preferably from 5 to 20 g/m² and more preferably from about 10 to 15 g/m². A dry weight of material in the under layer coated onto the support is preferably up to about 50 g/m², more preferably from 15 to 35 g/m² and most preferably about 25 g/m².

Optionally, further layers may be coated between the under layer and the upper layer and/or between any subbing layer or the support and the under layer, but preferably the ink-jet receiver comprises solely of a support, a subbing layer coated thereon, an under layer coated onto the subbing layer and an upper layer coated onto the under layer.

According to the particularly preferred embodiment of the invention described above and moreover where the laydowns are as described above, the amount of the second inorganic particulate material in the upper layer and the amount of binder in the under layer are preferably selected such as to provide a crack rating of 2 or 1, preferably 1, and an ink-laydown rate at which puddling is first observed of 29 ml/m² or greater, by for example, reference to the data in Tables 1 and 2. Accordingly, where the amount of PVA in the under layer is about 15% by weight of the combined weight of PVA and calcium carbonate in the under layer, the amount of colloidal silica in the upper layer may be chosen to be from 15-20% by weight of the inorganic material in the top layer in order to achieve a crack rating of 1 or 2 and an ink laydown rate at which puddling is first observed of about 29.5 ml/m². Where the amount of PVA in the under layer is about 10% by weight of the combined weight of PVA and calcium carbonate in the under layer, the amount of colloidal silica in the upper layer may be chosen to be from 10-25% by weight of the inorganic material in the top layer in order to achieve a crack rating of 1 or 2 and an ink laydown rate at which puddling is first observed of about 29.5 ml/m² and preferably the amount of colloidal silica may be chosen to be from 15-20% by weight in order to achieve a crack rating of 1 and an ink laydown rate at which puddling is first observed of about 31 ml/m². Where the amount of PVA in the under layer is about 5% by weight of the combined weight of PVA and calcium carbonate in the under layer, the amount of colloidal silica in the upper layer may be chosen to be from 10-25% by weight of the inorganic material in the top layer in order to achieve a crack rating of 1 and an ink laydown rate at which puddling is first observed of at least about 34.5 ml/m² and preferably the amount of colloidal silica may be chosen to be about 10% by weight in order to achieve a crack rating of 1 and an ink laydown rate at which puddling is first observed of about 36 ml/ft².

Such relative quantities may be extrapolated to provide a selection of suitable amounts of the respective components of the ink-jet receiver for other combinations and compositions of the layers of the ink-jet receiver of the present invention and such other selections are considered within the scope of the present invention.

Preferably, therefore, the under layer comprises a minimum amount of binder necessary to enable the binder to continue to effectively bind the inorganic particulate material in the under layer and the upper layer comprises a minimum amount of the second inorganic particulate material necessary in order to reduce the propensity of cracking of the ink-jet receiver to a crack rating of 1 or 2, preferably 1, in order to provide the maximal benefits of reduced cracking whilst minimising puddling on the surface of the ink-jet receiver of the invention.

The ink-jet receiver of the present invention may be used with pigment or dye based inks. It is a particularly effective receiver, however, when used with pigment-based inks.

The invention will now be described in detail, without limitation as to the scope of the invention, according to the following examples.

### EXAMPLES

### Example 1

A non resin-coated paper support was coated with three layers in two different passes through a coating track.

In the first pass through the coating track, a subbing layer was applied to the support. This consisted of a 70/30 mix of an aqueous dispersion of a sulfopolyester (Eastek® 1400) and Borax® decahydrate (sodium tetraborate decahydrate). Some surfactant (a mixture of the non-fluorocarbon surfactants Olin® 10G and TX-200E) was used to aid coating of this layer onto the support. The dry laydown of the Borax® decahydrate was dependent upon the dry laydown of binder used in the calcium carbonate bottom layer to be applied in the second pass through the coating track, where the weight ratio of binder in the bottom layer to Borax® decahydrate was 4:1. This layer was coated on a bead-coating machine using a slide over extrusion hopper.

In the second pass through the coating track, two more layers were applied on top of the subbing layer. The bottom layer next to the subbing layer contained calcium carbonate (Albaglos S™ supplied by Specialty Minerals) and PVA (Gohsenol® GH17 supplied by British Traders) as a binder. The total dry laydown of this layer was 25 g/m² with the ratio of calcium carbonate:PVA varying between 85:15 and 95:5. The top layer contained mixtures of fumed silica (Cab-O-Sperse® PG002 supplied by Cabot Corp) and colloidal silica (Ludox® PW-50 supplied by Grace Davison), PVA (Gohsenol® GH17 supplied by British Traders) as a binder and some surfactant (Zonyl® FSN). The total dry laydown of this layer was 15.2 g/m² with the silica/PVA/surfactant ratio of 89/10/1.

These two layers were coated simultaneously on a bead-coating machine using a slide over extrusion hopper.

Coatings A-R were prepared using the bottom layer binder levels and top layer fumed silica/colloidal silica combinations shown in Table 1. Coatings A, G and M were controls as no colloidal silica (Ludox® PW50) was added to the top layers.

TABLE 1
Formulation variations for coatings A-R.

| | | Bottom Layer | | | | | | |
|---|---|---|---|---|---|---|---|---|
| | Sub Layer | Calcium | | | Top Layer | | | |
| | Borax | Carbonate | PVA | % | PG002 | PW50 | % | % |
| Ctg | (g/m²) | (g/m²) | (g/m²) | PVA | (g/m²) | (g/m²) | PG002 | PW50 |
| A | 0.938 | 21.25 | 3.75 | 15% | 13.50 | — | 100% | — |
| B | 0.938 | 21.25 | 3.75 | 15% | 12.83 | 0.68 | 95% | 5% |
| C | 0.938 | 21.25 | 3.75 | 15% | 12.15 | 1.35 | 90% | 10% |
| D | 0.938 | 21.25 | 3.75 | 15% | 11.48 | 2.03 | 85% | 15% |
| E | 0.938 | 21.25 | 3.75 | 15% | 10.80 | 2.70 | 80% | 20% |
| F | 0.938 | 21.25 | 3.75 | 15% | 10.13 | 3.38 | 75% | 25% |
| G | 0.625 | 22.50 | 2.50 | 10% | 13.50 | — | 100% | — |
| H | 0.625 | 22.50 | 2.50 | 10% | 12.83 | 0.68 | 95% | 5% |
| I | 0.625 | 22.50 | 2.50 | 10% | 12.15 | 1.35 | 90% | 10% |
| J | 0.625 | 22.50 | 2.50 | 10% | 11.48 | 2.03 | 85% | 15% |
| K | 0.625 | 22.50 | 2.50 | 10% | 10.80 | 2.70 | 80% | 20% |
| L | 0.625 | 22.50 | 2.50 | 10% | 10.13 | 3.38 | 75% | 25% |
| M | 0.313 | 23.75 | 1.25 | 5% | 13.50 | — | 100% | — |
| N | 0.313 | 23.75 | 1.25 | 5% | 12.83 | 0.68 | 95% | 5% |
| O | 0.313 | 23.75 | 1.25 | 5% | 12.15 | 1.35 | 90% | 10% |
| P | 0.313 | 23.75 | 1.25 | 5% | 11.48 | 2.03 | 85% | 15% |
| Q | 0.313 | 23.75 | 1.25 | 5% | 10.80 | 2.70 | 80% | 20% |
| R | 0.313 | 23.75 | 1.25 | 5% | 10.13 | 3.38 | 75% | 25% |

A qualitative evaluation of the coatings was then made ranging from 4 to 1 (see key below):

4=extremely cracked

3=less cracking

2=minor cracking

1=no cracking.

Table 2 shows how the variation in formulation affected the cracking and the ink laydown (in ml/m²) where puddling began.

TABLE 2
Formulation effects on cracking and puddling

| | | Ink laydown Where Puddling Begins |
|---|---|---|
| Ctg | Crack Rating | (ml/m²) |
| A | 4 | 32.8 |
| B | 4 | 31.2 |
| C | 3 | 31.2 |
| D | 2 | 29.6 |
| E | 1 | 29.6 |
| F | 1 | 29.0 |
| G | 4 | 34.8 |
| H | 3 | 34.8 |
| I | 2 | 32.8 |
| J | 1 | 31.2 |
| K | 1 | 31.2 |
| L | 1 | 29.6 |
| M | 3 | 36.6 |
| N | 2 | 36.6 |
| O | 1 | 36.6 |
| P | 1 | 34.8 |
| Q | 1 | 34.8 |
| R | 1 | 34.8 |

The data in Table 2 indicate that whatever binder level was used in the bottom layer, cracking could be overcome by replacing some of the fumed silica (PG002) in the top layer with colloidal silica (Ludox® PW-50) and that as the binder level was reduced in the bottom layer, so less colloidal silica was needed in the top layer to prevent cracking.

This is beneficial, as the presence of colloidal silica appears to initiate puddling at a lower ink laydown. In coatings A-F where 15% binder was used in the bottom layer, 20% of the fumed silica needed to be replaced with colloidal silica before the cracking disappeared and this resulted in puddling occurring at a lower ink laydown compared to when no colloidal silica was present. However, when the bottom layer only contained 5% binder (coatings M-R), only 10% of the fumed silica needed to be replaced with colloidal silica before the cracking was overcome and this lower level did not affect the ink laydown that caused puddling.

1. An ink-jet receiver having
a support and, in order;
an under layer comprising an inorganic particulate material and a binder, said binder being present in an amount of up to 25% by weight of the combined weight of said inorganic particulate material and said binder in said under layer; and
an upper layer comprising a binder, a first inorganic particulate material having a mean particulate diameter of 500 nm or less and a second inorganic particulate material having a mean particulate diameter of 200 nm or less, wherein said second inorganic particulate material has a mean particulate diameter less than that of said first inorganic particulate material and is present in an amount of up to 25% by weight of the total inorganic particulate material laydown in said upper layer.

2. An ink-jet receiver as claimed in claim 1, wherein said second inorganic particulate material has a mean diameter of from 25% to 75% of that of said first inorganic particulate material.

3. An ink-jet receiver as claimed in claim 2, wherein said second inorganic particulate material has a mean diameter of from 40% to 70% of that of said first inorganic particulate material.

4. An ink-jet receiver as claimed in claim 1, which further comprises a subbing layer between said under layer and said support.

5. An ink-jet receiver as claimed in claim 4, wherein said subbing layer comprises a boric acid, borate or derivative and/or salt thereof.

6. An ink-jet receiver as claimed in claim 1, wherein said binder in said under layer is present in an amount of from 1% to 20% by weight of the combined weight of said inorganic particulate material and said binder in said under layer.

7. An ink-jet receiver as claimed in claim 6, wherein said binder in said under layer is present in an amount of from 2% to 10% by weight of the combined weight of said inorganic particulate material and said binder in said under layer.

8. An ink-jet receiver as claimed in claim 1, wherein said second inorganic particulate material is present in an amount of from 3% to 20% by weight of the total inorganic particulate material laydown in said upper layer.

9. An ink-jet receiver as claimed in claim 8, wherein said second inorganic particulate material is present in an amount of from 5% to 15% by weight of the total inorganic particulate material laydown in said upper layer.

10. An ink-jet receiver as claimed in claim 1, wherein said first inorganic particulate material has a mean diameter of from 120 to 180 nm and said second inorganic particulate material has a mean diameter of from 60 to 100 nm.

11. An ink-jet receiver as claimed in claim 1, wherein said first inorganic particulate material is fumed silica and said second inorganic particulate material is colloidal silica.

12. An ink-jet receiver as claimed in claim 1, wherein said inorganic particulate material in said under layer is calcium carbonate.

13. An ink-jet receiver as claimed claim 1, wherein said binder in both said under layer and said upper layer is polyvinyl alcohol.

14. An ink-jet receiver as claimed in claim 1, wherein said support is a non resin-coated paper.

15. A method of manufacturing an ink-jet receiver, said ink-jet receiver having
a support:
an under layer comprising an inorganic particulate material and a binder and
an upper layer comprising a binder, a first inorganic particulate material and a second inorganic particulate material,
said method comprising
coating a first coating formulation onto said support to form said under layer on said support, said first coating formulation comprising an aqueous dispersion of said inorganic particulate material and said binder, said binder being present in an amount of up to 25% by weight of the combined weight of said inorganic particulate material and said binder in said under layer;
coating onto said first coating formulation a second coating formulation to form said upper layer on said under layer, said second coating formulation comprising an aqueous dispersion of said binder, said first inorganic particulate material having a mean diameter of 500 nm or less and said second inorganic particulate material having a mean diameter of 200 nm or less, wherein said second inorganic particulate material has a mean diameter less than that of said first inorganic particulate material and is present in an amount of up to 25% by weight of the total inorganic particulate material laydown in said upper layer and
drying the coated support.

16. A method as claimed in claim 15, which comprises coating a subbing formulation onto said support prior to coating said first coating formulation.

17. A method as claimed in claim 15, which method comprises coating each of said formulations onto said support by an extrusion coating method.

18. A method of preventing cracking in an ink-jet receiver comprising a support and, in order, an under layer comprising a binder and an inorganic particulate material and an upper layer comprising a binder and a mixture of a first inorganic particulate material having a mean diameter of 500 nm or less and a second inorganic particulate material having a mean diameter of 200 nm or less, which said second inorganic particulate material has a mean diameter less than that of said first inorganic particulate material, by incorporating said binder material in said under layer in varying amounts relative to said second inorganic particulate material thereby preventing cracking whilst controlling rate of ink uptake.

19. A method of printing, said method comprising the steps of providing an ink-jet printer capable of responding to digital data signals, providing said printer with ink, providing the printer with an ink-jet receiver, and causing a set of digital signals corresponding to a desired printed image to be sent to said printer, said ink-jet receiver having
a support and, in order;
an under layer comprising an inorganic particulate material and a binder, said binder being present in an amount of up to 25% by weight of the combined weight of said inorganic particulate material and said binder in said under layer; and
an upper layer comprising a binder, a first inorganic particulate material having a mean particulate diameter of 500 nm or less and a second inorganic particulate material having a mean particulate diameter of 200 nm or less, wherein said second inorganic particulate material has a mean particulate diameter less than that of said first inorganic particulate material and is present in an amount of up to 25% by weight of the total inorganic particulate material laydown in said upper layer

20. (canceled)
